(19) United States
(12) Patent Application Publication
(10) Pub. No.: US 2017/0283184 A1
(43) Pub. Date: Oct. 5, 2017

(54) System for Removing Shards From Table-Top Conveyors

(71) Applicant: Jet Air Technologies, Inc., Ventura, CA (US)

(72) Inventor: Daniel G. Snyder, Santa Barbara, CA (US)

(21) Appl. No.: 15/473,288

(22) Filed: Mar. 29, 2017

Related U.S. Application Data
(60) Provisional application No. 62/314,784, filed on Mar. 29, 2016.

(51) Int. Cl. B65G 45/22

(52) U.S. Cl. CPC B65G 45/22

(57) ABSTRACT

Systems, devices, and methods including: a conveyor belt (302) having a plurality of openings (608, 610, 612); a first plurality of nozzles (314) disposed in complementary opposition to a top surface (310) of the conveyor belt; a shard plate (318, 320) disposed below the top surface of the conveyor belt opposite from the plurality of nozzles, the shard plate disposed at an angle from the conveyor belt; and a shard catch (322, 324) disposed along at least one edge of the shard plate; where shard passes through the openings of the conveyor belt, falls onto the shard plate, and is collected in the shard catch.

### CROSS-REFERENCE TO RELATED APPLICATIONS

This application claims priority to and the benefit of U.S. Provisional Patent Application No. 62/314,784, filed Mar. 29, 2016, the contents of which are hereby incorporated by reference herein for all purposes.

### TECHNICAL FIELD

Embodiments relate generally to systems, methods, and devices for conveyor belts, and more particularly, to conveyor belt systems used to dry and clean containers.

### BACKGROUND

Consumer products that are liquid products packaged in glass containers are conveyed through the packaging process on table-top conveyors. Many glass containers are broken as they are being conveyed in the packaging process. Shards from broken containers, such as glass shards, are a costly problem because shards damage the conveyors, injure personnel, and are difficult to separate and collect from the conveyor itself. The industry's move toward the use of thinner and lighter weight glass is exacerbating the problem. A need continues to exist to reduce the incidence and damaging effects of glass shards and other material shard caused by broken containers on conveyor lines used in the container packaging process.

### SUMMARY

Exemplary system embodiments may include: a conveyor belt having a plurality of openings; a first plurality of nozzles disposed in complementary opposition to a top surface of the conveyor belt; a shard plate disposed below the top surface of the conveyor belt opposite from the plurality of nozzles, the shard plate disposed at an angle from the conveyor belt; and a shard catch disposed along at least one edge of the shard plate; where shard may pass through the openings of the conveyor belt, fall onto the shard plate, and be collected in the shard catch. At least one of the first plurality of nozzles may be an air knife. The system may also include: a second plurality of nozzles disposed between the top surface of the conveyor belt and the shard plate, the second plurality of nozzles directed at the shard plate; where shard that falls onto the shard plate is compelled into the shard catch by the second plurality of nozzles. The conveyor belt may be a chain-type conveyor belt and may have an open area of 35%-65%.

In additional system embodiments, the first plurality of nozzles may include liquid spray nozzles, gas spray nozzles, and/or drying nozzles. The system may also include a second plurality of nozzles disposed in complementary opposition to the conveyor belt, where the second plurality of nozzles may include drying nozzles. The system may also include a second conveyor belt having a second plurality of openings, where the second conveyor belt may be spaced apart from and disposed above the first conveyor belt. The shard plate may be planar or pitched along its centerline.

Exemplary method embodiments may include: translating a conveyor belt having a plurality of openings past a first plurality of nozzles disposed in complementary opposition to a top surface of the conveyor belt; blowing a plurality of shards using the first plurality of nozzles from the top surface of the conveyor belt in a trajectory through openings of the plurality of openings in the translating conveyor belt; and receiving the plurality of shards on the shard plate. The shard plate may be made of stainless steel. Additional method embodiments may include translating the plurality of shards across at least a portion of the shard plate and into a shard catch using gravity. The shard catch may include a drawer, and the drawer may have a water-transmissive floor so that water received in the drawer passes through the drawer.

Additional method embodiments may include: pushing the plurality of shards across at least a portion of the shard plate and into a shard catch using water directed from a second plurality of nozzles disposed between the conveyor belt and the shard plate, the second plurality of nozzles directed at the shard plate. Additional method embodiments may include: pushing the plurality of shards across at least a portion of the shard plate and into a shard catch using air directed from a second plurality of nozzles disposed between the conveyor belt and the shard plate, where the second plurality of nozzles may be directed at the shard plate.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a front view of an exemplary conveyor belt filter system;

FIG. 2 depicts a perspective view of the exemplary conveyor belt filter system of FIG. 1;

FIG. 3 depicts a side view of an exemplary conveyor belt filter system for removing glass shards from a production line;

FIG. 4 depicts a cross-sectional view of the exemplary conveyor belt filter system of FIG. 3 about line 4-4;

FIG. 5 depicts a cross-sectional view of another embodiment of the exemplary conveyor belt filter system having a shard plate pitched along its centerline;

FIG. 6A depicts a top view of an exemplary conveyor belt having a plurality of openings to pass glass shards through;

FIG. 6B depicts a top view of another embodiment of a conveyor belt having a plurality of openings to pass glass shards through;

FIG. 7 depicts a front view of an exemplary double deck conveyor belt filter system;

FIG. 8 depicts a perspective view of the exemplary double deck conveyor belt filter system of FIG. 7;

FIG. 9 depicts an exemplary dead plate disposed between an exemplary conveyor belt filter system and a delivery conveyor belt; and

FIG. 10 depicts a top view of a production line having an exemplary dead plate and an exemplary conveyor belt filter system.

### DETAILED DESCRIPTION

An exemplary conveyor belt filter system is described that includes a conveyor belt having a plurality of openings, a first plurality of nozzles disposed in complementary opposition to the conveyor belt, a shard plate disposed on a side of the conveyor belt opposite from the plurality of nozzles, the shard plate disposed at an angle from or otherwise sloped from the conveyor belt, and a shard catch disposed along at least one edge of the shard plate so that shard passing through the openings of the conveyor belt may fall into the shard plate. By flushing objects from the conveyor line down through the conveyor belt and into a shard plate for delivery to a shard catch for later removal, the objects may be removed from the remainder of the conveyor line and away from operating personnel to reduce the opportunity for damage to both.

In some embodiments, at least one of the plurality of nozzles may be an air knife. The system may also include a second plurality of nozzles disposed between the conveyor belt and the shard plate, the second plurality of nozzles directed at the shard plate so that shard that falls onto the shard plate, when objects are present, are pushed or otherwise compelled further onto the shard catch by the second plurality of nozzles. The conveyor belt may be a chain-type conveyor belt. In an exemplary embodiment, the chain-type conveyor belt may have an open area of 35%-65%. The first plurality of nozzles described above may include liquid spray nozzles, drying nozzles or some combination of both. The second plurality of nozzles may be disposed in complementary opposition to the conveyor belt, with the second plurality of nozzles including drying nozzles. The shard plate may be planar or may be pitched along the centerline of the shard plate.

In certain configurations, a second conveyor belt may be included that has a second plurality of openings, the second conveyor belt spaced apart from and disposed on top of the first conveyor belt.

A conveyor belt filter method is also described below that includes translating a conveyor belt having a plurality of openings past a first plurality of nozzles disposed in complementary opposition to the conveyor belt, blowing a plurality of glass shards using the first plurality of nozzles from a top of the conveyor belt in a trajectory through respective ones of the plurality of openings in the translating conveyor belt, and receiving the plurality of shards on the shard plate. In one embodiment, the shard plate may be formed of stainless steel. The method may also include translating the plurality of shards across at least a portion of the shard plate and into the shard catch, for example, using gravity. In certain embodiments, the shard catch includes a drawer, and the drawer may have a water-transmissive floor so that water received in the drawer passes through the drawer. The method may also include the steps of pushing the plurality of shards across at least a portion of the shard plate and into a shard catch using water directed from a second plurality of nozzles disposed between the conveyor belt and the shard plate, the second plurality of nozzles directed at the shard plate. Alternatively, the steps may include pushing the plurality of shards across at least a portion of the shard plate and into a shard catch using air directed from a second plurality of nozzles disposed between the conveyor belt and the shard plate, the second plurality of nozzles directed at the shard plate.

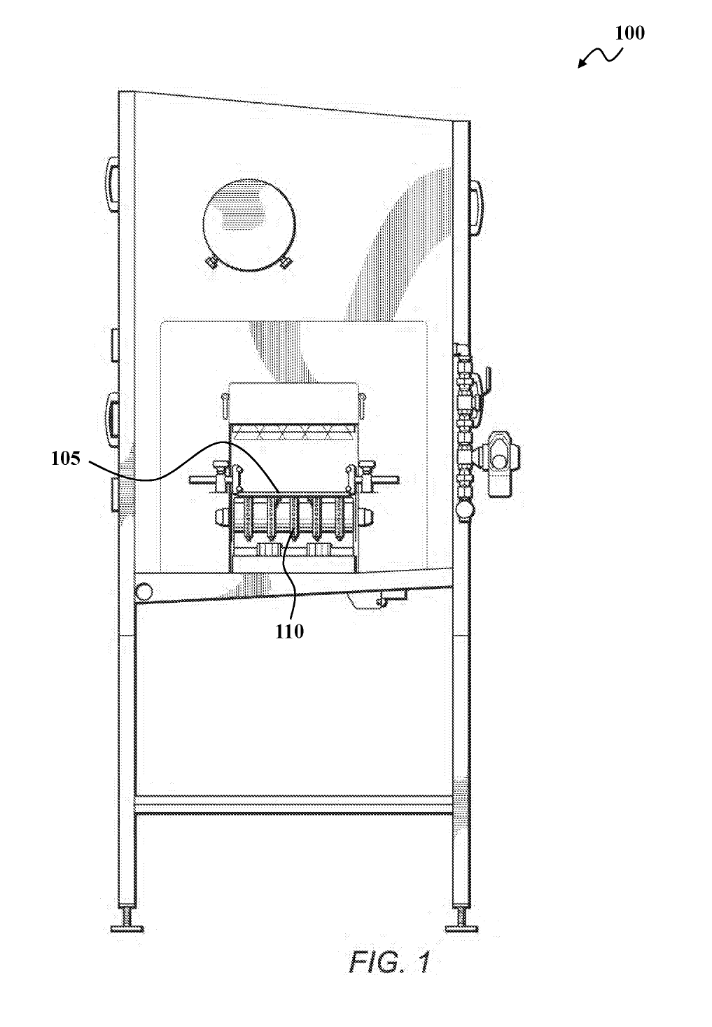

FIG. 1 depicts a front view of an exemplary conveyor belt filter system 100. The conveyor belt 105 may be driven by a plurality of cogs 110. A portion of the conveyor belt 105 near the cogs has been removed to illustrate the cogs 110 that drive the conveyor belt 105. During operation, the conveyor belt would extend contiguously from the top of belt portion down around to engage the cogs 110 and return back into the system 100 to complete what is a continuous conveyor belt.

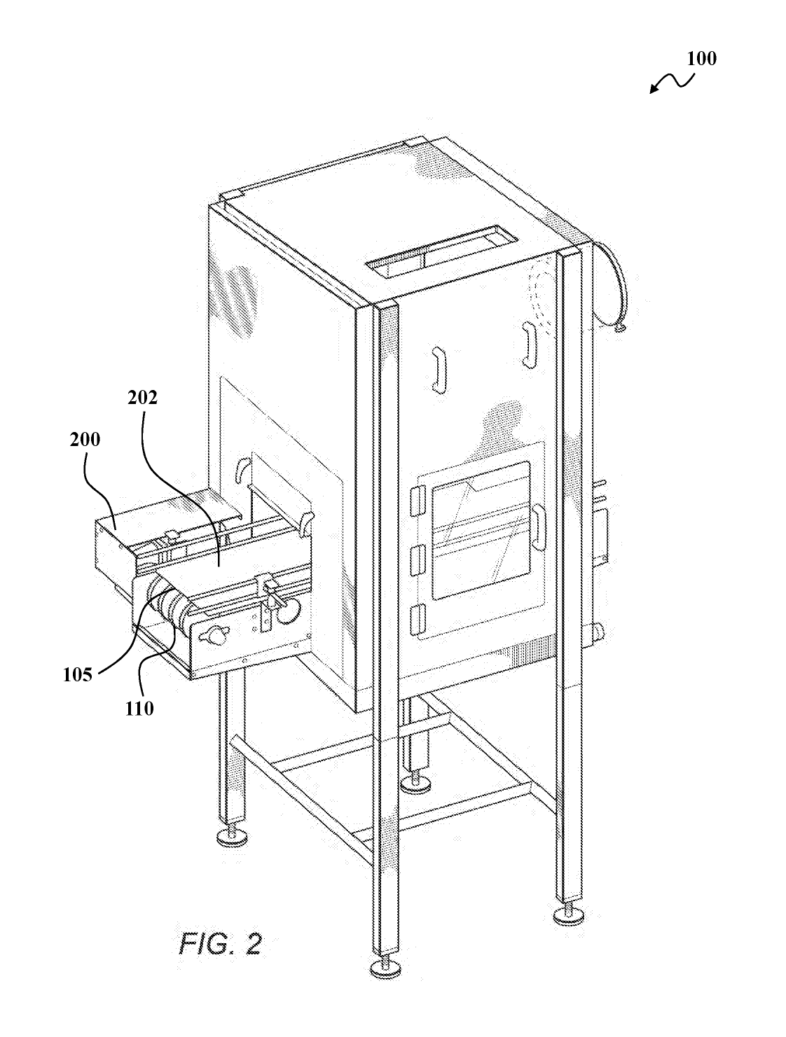

FIG. 2 depicts a perspective view of the exemplary conveyor belt filter system of FIG. 1. A motor 200 may drive the conveyor belt 105 via the plurality of cogs 110. A portion of the conveyor belt has been removed to illustrate the cogs 110 underneath. A top surface 202 of the conveyor belt may be used to transport glass bottles through the system 100. Broken glass bottles create shards that may damage other equipment on a production line. The surface of the conveyor belt 105 may include a plurality of openings (See FIGS. 6A-6B) to allow the glass shards to fall through.

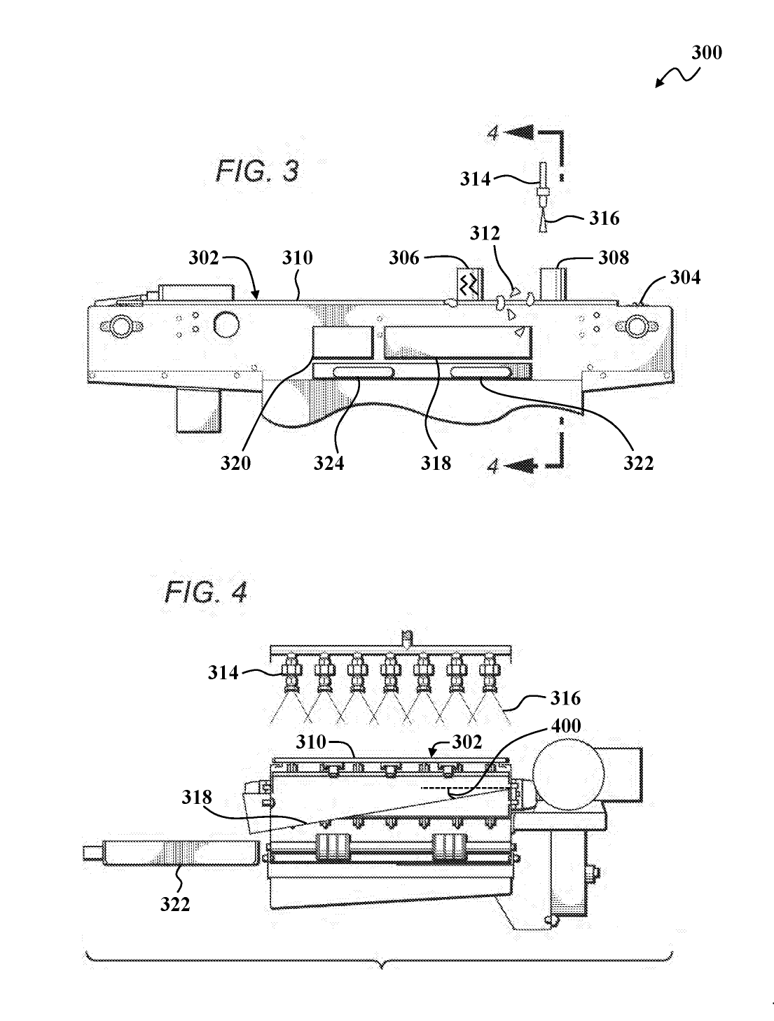

FIG. 3 depicts a side view of an exemplary conveyor belt filter system 300 for removing glass shards from a production line. The system may include a conveyor belt 302 driven by a plurality of cogs 304. The conveyor belt 302 may transport a plurality of glass bottles, such as broken bottle 306 and unbroken bottle 308. These bottles 306, 308 may be on a top surface 310 of the conveyor belt 302.

A broken bottle 306 may create a plurality of glass shards 312. Some of the glass shards 312 may be small enough to fall through openings in the conveyor belt 302. Other glass shards 312 may be trapped on a top surface 310 of the conveyor belt where they could be transported further down a production line to other equipment or conveyor belts.

A nozzle 314 may be disposed in complementary opposition to the top surface 310 of the conveyor belt 302. The nozzle 314 may direct gaseous matter, such as air, or liquid 312 toward the top surface 310 of the conveyor belt 302 to flush the glass shards 312 through openings in the conveyor belt 302. An exemplary water flow may be two gallons/minute per nozzle. An exemplary air-flow may be 15″WG @ 300 cfm or more to 110 psi @ 10 cfm. The top surface 310 of the conveyor belt 302 exiting to the right side of the system will be free of any glass shards. Accordingly, these glass shards will not be passed on to other conveyor belts or equipment on a production line.

The glass shards 312 may fall through openings in the conveyor belt 302 and onto at least one shard plate 318, 320. In the illustrated embodiment, the shard plates 318, 320 may include two plates that may each be planar and configured to receive, for example, glass shards 312 that may be riding on a top surface 310 of the conveyor belt 302 as a result of a broken bottle 306. Such glass shards 312 may be flushed or otherwise blown by liquid or gas 316 from the one or more nozzles 314 disposed above and directed toward the conveyor belt 302, off of the top surface 310 of the conveyor belt 302 down through openings in the conveyor belt (See FIGS. 6A-6B) for delivery to one or more shard catches 322, 324.

FIG. 4 depicts a cross-sectional view of the exemplary conveyor belt filter system of FIG. 3 about line 4-4. Liquid or gas 316 may be directed toward the top surface 310 of the conveyor belt 302 by a plurality of nozzles 314. In one embodiment, there may be a plurality of nozzles 314 that are liquid nozzles to direct liquid, such as water, onto the conveyor belt 302. In another embodiment, the plurality of nozzles 314 may be gas nozzles to direct gas, such as compressed air, onto the conveyor belt 302. In further embodiments, the nozzles 314 may be some combination of liquid or gas nozzles, such as an air knife disposed at one location and water nozzles disposed at another location along and above the conveyor belt. The shards may then fall through openings in the conveyor belt 302 and into a shard plate 318. The shard plate 318 and shard catch 322 may be disposed beneath the top surface 310 of the conveyor belt 302. The shard plate 318 may be disposed at an angle (Ø) 400 from the top surface 310 of the conveyor belt 302 to facilitate translation of the shards down and into the shard catch 322 for later disposal by an operator. The shard catch 322 may be a removable container for storing glass shards. The shard catch 322 may be sized to accommodate an expected number of shards from a production line, such that the line does not need to be stopped so that the shard catch 322 can be emptied.

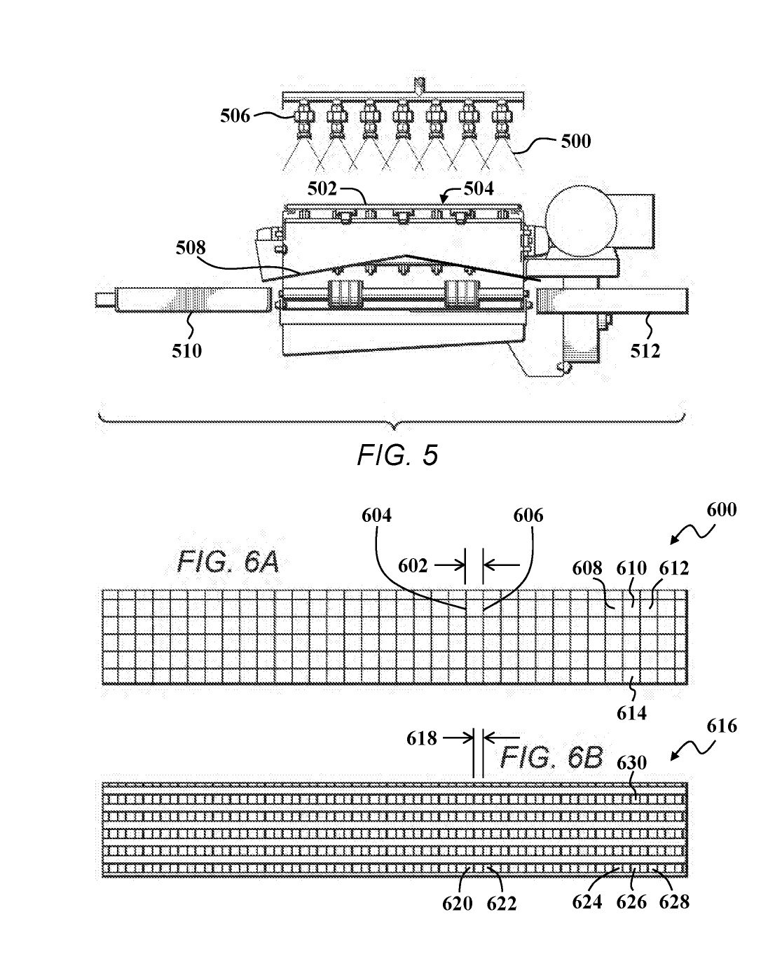

FIG. 5 depicts a cross-sectional view of another embodiment of the exemplary conveyor belt filter system having a shard plate pitched along its centerline. Liquid or gas 500 may be directed toward a top surface 502 of a conveyor belt 504 by a plurality of nozzles 506. Shards on the top surface 502 of the conveyor belt fall through openings in the conveyor belt 504 and into a shard plate 508. The shard plate 508 and shard catch 510 are disposed beneath the top surface 502 of the conveyor belt 504. The shard plate 508 may be pitched along its centerline to slope from a middle of the conveyor belt 504 down toward two shard catches 510, 512 adjacent the longitudinal ends of the shard plate 508. The shard plate 508 may form an “A” shape for delivery of glass shards or other foreign objects received from the top surface 502 of the conveyor belt 504 to the shard catches 510, 512.

FIG. 6A depicts a top view of an exemplary conveyor belt 600 having a plurality of openings to pass glass shards through. The conveyor belt 600 may have a first pitch (P_{DL}) 602 between adjacent links 604, 606. Adjacent openings 608, 610, 612 have a first opening area (A₁) 614.

FIG. 6B depicts a top view of another embodiment of a conveyor belt 616 having a plurality of openings to pass glass shards through. The conveyor belt 616 may have a second pitch (P_{D2}) 618 between adjacent links 620, 622. Adjacent openings 624, 626, 628 have a second opening area (A₂) 630. The pitch and opening areas may be varied based on the production line and likely size of any resulting shards. By way of example only, and not limitation, each of the conveyor belts 600, 616 may be a Rexmord belt model number 6938 offered by Rexnord Corporation of West Milwaukee, Wis., or Intralox belt Series 9000 having a 1.01-inch pitch offered by Intralox, LLC of Harahan, La.

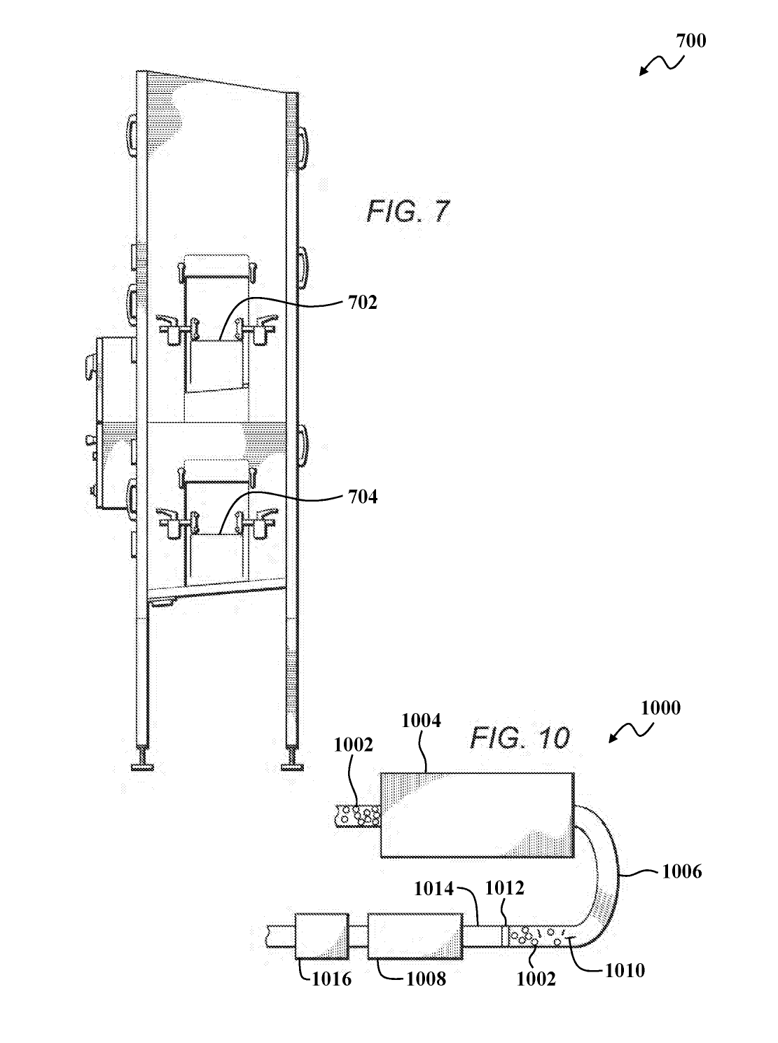

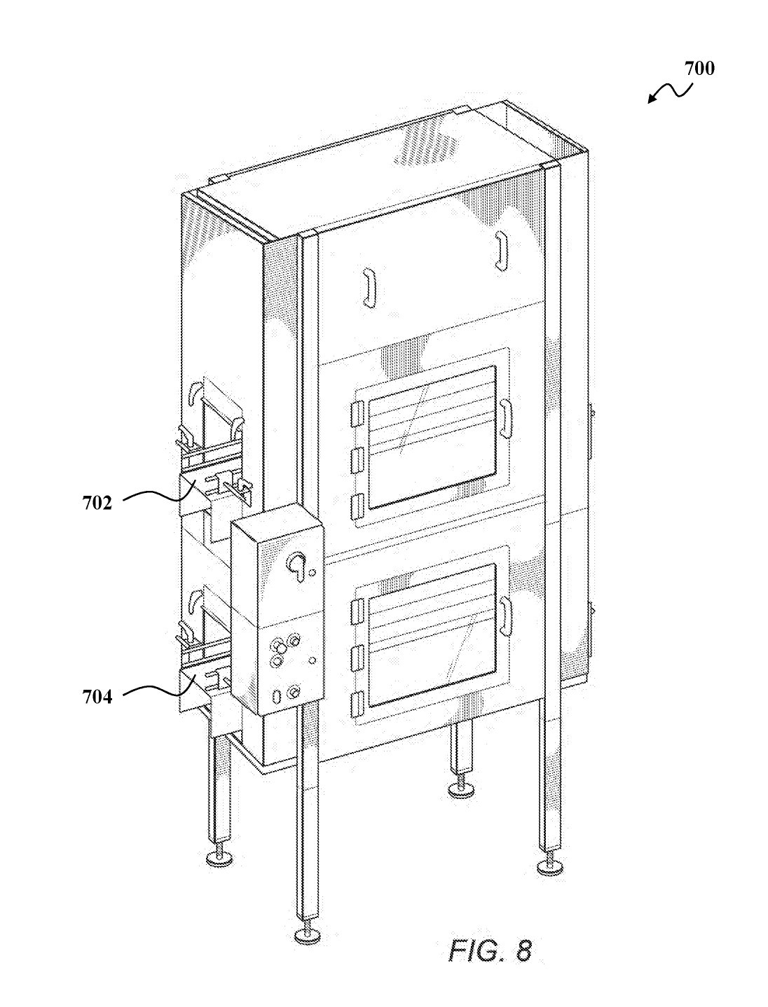

FIG. 7 depicts a front view of an exemplary double deck conveyor belt filter system 700. FIG. 8 depicts a perspective view of the exemplary double deck conveyor belt filter system of FIG. 7. The system 700 may have a top conveyor belt 702 and a bottom conveyor belt 704. The top conveyor belt 702 and bottom conveyor belt 704 may each have a plurality of openings for transmission of damaging bottle shards onto respective shard plates for delivery to respective shard catches for later disposal by an operator.

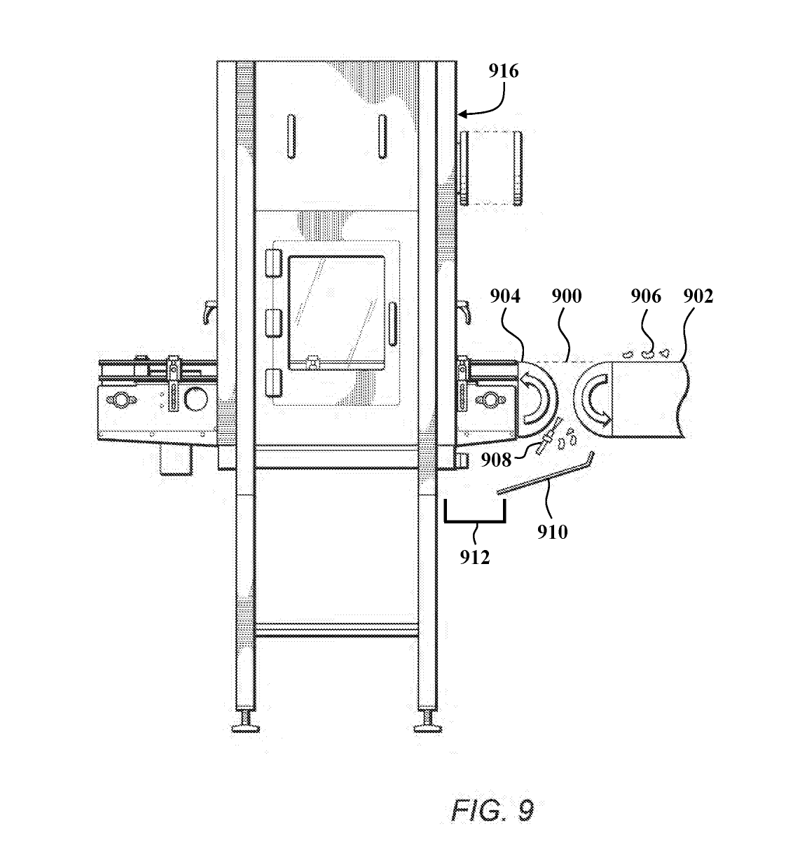

FIG. 9 depicts an exemplary dead plate disposed between an exemplary conveyor belt filter system and a delivery conveyor belt. Movement and rotation of the conveyor belts are indicated with arrows. A dead plate 900 may be positioned between a delivery conveyor belt 902 and a filter conveyor belt 904. The dead plate 900 is a flat plate having a plurality of holes or spaces through which glass shards 906 may fall if pushed by the delivery conveyor belt 902 onto the dead plate 900.

A nozzle 908 may be positioned beneath the dead plate 900 to blow glass shards 906 that may have remained on the delivery conveyor belt 902 as it begins to transition from horizontal translation down around the cogs (not shown) and back into a delivery conveyor belt system. The nozzle 908 may be a gas nozzle delivering compressed air or a liquid nozzle delivering water. The gas or liquid from the nozzle 908 may ensure that any glass shards 906 that were not caught by the dead plate 900 are removed from the conveyor delivery belt 902. Glass shards remaining in a conveyor belt may severely limit the lifespan of the conveyor belt, resulting in costly and more frequent replacements.

The glass shards 906 removed via the dead plate 900 or the nozzle 908 may fall onto a shard plate 910 and be collected in a shard catch 912. Any remaining glass shards on the filter conveyor belt 904 may be removed by a filter system 916 such as those shown in FIGS. 1-5. Accordingly, any equipment or conveyor belts downstream in the product line will not contain any glass shards 906 carried from the delivery conveyor belt 902.

FIG. 10 depicts a top view of a production line 1000 having an exemplary dead plate and an exemplary conveyor belt filter system. Bottles 1002 may be introduced to a pasteurizer 1004 for pasteurization, and then to a delivery conveyor belt 1006 which may move the bottles 1002 forward to a conveyor drying and filter system 1008. Throughout the process, a portion of the bottles 1002 may experience breakage, thus creating glass shards 1010. As the delivery conveyor belt 1006 translates the remaining bottles 1002 over a dead plate 1012 intended to bridge adjacent conveyor belt 1014, the dead plate 1012 may receive and pass through a portion of the glass shards 1010 to remove the glass shards 1010 from the system 1000.

A second portion of the glass shards 1010, such as glass shards 1020 that may remain on any one or more of the remaining bottles 1002, are then received by the drying and filter system 1008. A plurality of nozzles that are disposed in complementary opposition to the conveyor belt, such as directed at a top surface of the conveyor belt, are configured to wash or blow air over the bottles 1002 and the top surface to push or compel the glass shards down through openings in the conveyor belt and onto a shard plate extending beneath the conveyor belt to be collected in a shard catch (See FIGS. 3-5, 6A, and 6B). In this manner, any glass shards 1010 that remain on either the bottles 1002 or on the top of the conveyor belts are removed from the system 1000. The bottles 1002 may then be delivered without glass shards to downstream systems, such as a labeler 1016.

Bottles 1002 leaving the pasteurizer 1004 may be wet with condensation. The temperature fluctuations in the glass bottles 1002 during the heating and cooling process may make bottles 1002 more likely to shatter. Any glass impurities or variations due to thin or cheaper glass being used may cause some bottles 1002 to explode or break, resulting in a plurality of shards 1010. The conveyor drying filter system 1008 may remove any glass shards with gas from the nozzles. The nozzles may also dry the bottles so that they may be: coded, labeled, have tamper evidence sleeves applied, reduce the likelihood of rust forming from any remaining condensation, be packaged without the likelihood of developing mold in the packaging, etc. The conveyor drying filter system 1008 may be placed at the discharge of a pasteurizer 1004, but before any packaging activities. While a linear line with conveyor belts is depicted here, the same principles may be applied to a rotary machine, such as a rotary filler.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A conveyor belt filter system, comprising:
a conveyor belt having a plurality of openings;
a first plurality of nozzles disposed in complementary opposition to a top surface of the conveyor belt;
a shard plate disposed below the top surface of the conveyor belt opposite from the plurality of nozzles, the shard plate disposed at an angle from the conveyor belt; and
a shard catch disposed along at least one edge of the shard plate;
wherein shard passes through the openings of the conveyor belt, falls onto the shard plate, and is collected in the shard catch.

2. The system of claim 1, wherein at least one of the first plurality of nozzles is an air knife.

3. The system of claim 1, further comprising:
a second plurality of nozzles disposed between the top surface of the conveyor belt and the shard plate, the second plurality of nozzles directed at the shard plate;
wherein shard that falls onto the shard plate is compelled into the shard catch by the second plurality of nozzles.

4. The system of claim 1, wherein the conveyor belt is a chain-type conveyor belt.

5. The system of claim 4, wherein the chain-type conveyor belt has an open area of 35%-65%.

6. The system of claim 1, wherein the first plurality of nozzles comprises liquid spray nozzles and gas spray nozzles.

7. The system of claim 1, wherein the first plurality of nozzles comprises drying nozzles.

8. The system of claim 1, wherein the first plurality of nozzles comprises liquid spray nozzles.

9. The system of claim 8, further comprising a second plurality of nozzles disposed in complementary opposition to the conveyor belt, the second plurality of nozzles comprising drying nozzles.

10. The system of claim 1, further comprising:
a second conveyor belt having a second plurality of openings, the second conveyor belt spaced apart from and disposed above the first conveyor belt.

11. The system of claim 1, wherein the shard plate is planar.

12. The system of claim 1, wherein the shard plate is pitched along its centerline.

13. A conveyor belt filter method, comprising:
translating a conveyor belt having a plurality of openings past a first plurality of nozzles disposed in complementary opposition to a top surface of the conveyor belt;
blowing a plurality of shards using the first plurality of nozzles from the top surface of the conveyor belt in a trajectory through openings of the plurality of openings in the translating conveyor belt; and
receiving the plurality of shards on the shard plate.

14. The method of claim 13, wherein the shard plate comprises stainless steel.

15. The method of claim 13, further comprising:
translating the plurality of shards across at least a portion of the shard plate and into a shard catch using gravity.

16. The method of claim 15, wherein the shard catch comprises a drawer.

17. The method of claim 16, wherein the drawer has a water-transmissive floor so that water received in the drawer passes through the drawer.

18. The method of claim 13, further comprising:
pushing the plurality of shards across at least a portion of the shard plate and into a shard catch using water directed from a second plurality of nozzles disposed between the conveyor belt and the shard plate, the second plurality of nozzles directed at the shard plate.

19. The method of claim 13, further comprising:
pushing the plurality of shards across at least a portion of the shard plate and into a shard catch using air directed from a second plurality of nozzles disposed between the conveyor belt and the shard plate, the second plurality of nozzles directed at the shard plate.
